(19) United States
(12) Patent Application Publication
(10) Pub. No.: US 2025/0329132 A1
(43) Pub. Date: Oct. 23, 2025

(54) DETERMINING SIMILAR ITEMS USING GROUPED IMAGES

(71) Applicant: Walmart Apollo, LLC, Bentonville, AR (US)

(72) Inventors: Akshit Sarpal, Santa Clara, CA (US); Raviteja Uppalapati, San Francisco, CA (US); Sayan Biswas, San Jose, CA (US); Rajesh Narasimha Reddy, Milpitas, CA (US); Samrat Kokkula, Houston, TX (US)

(21) Appl. No.: 19/026,265

(22) Filed: Jan. 16, 2025

Related U.S. Application Data
(60) Provisional application No. 63/635,876, filed on Apr. 18, 2024.

(51) Int. Cl. G06V 10/74; G06F 16/532; G06V 10/32

(52) U.S. Cl. CPC G06V 10/761; G06F 16/532; G06V 10/32

(57) ABSTRACT

Systems and methods for image retrieval are disclosed. In an example, sets of catalog images are received, wherein each set of catalog images is associated with a catalog item of a plurality of catalog items. Respective catalog embeddings representing each set of catalog images are generated. Query images associated with a query item are received. Query embeddings representing the query images are generated. Based on comparisons of the query images and the catalog images, select a candidate set of catalog items from the plurality of catalog items. Based on a comparison of the query embeddings and respective catalog embeddings associated with respective catalog items of the candidate set, generate respective similarity scores. Based on the similarity scores, determine that the query item is similar to a candidate catalog item, and in response identify the query item for review.

### CROSS-REFERENCE TO RELATED APPLICATIONS

This application claims priority to U.S. Provisional Patent Application No. 63/635,876, filed Apr. 18, 2024, entitled “Systems and Methods for Similar Retrieval Using Grouped Images,” which is incorporated by reference herein in its entirety.

### TECHNICAL FIELD

This application relates generally to entity retrieval based on image-generated signals, and more particularly, to entity retrieval based on image-group based signals.

### BACKGROUND

Some current systems provide image retrieval by searching and retrieving images from an image database. These systems typically rely on metadata associated with each image, such as captions, keywords, or descriptions, to facilitate text-based searchability of the image database. Some system employ limited versions of content-based image retrieval or instance-based image retrieval (IIR) to obtain images based on single image input data (e.g., similarity of a retrieved image to a single reference image).

Although these systems employ a one-to-one image-based retrieval, they are not capable of searching image databases for entities represented by a collection of images. For example, entities are frequently represented by groups of images, such as product listings on an e-commerce website, hotel rooms or destinations on a travel portal, or user-visited locations on social media platforms. There are numerous practical applications that necessitate the identification of similar products, hotels, or places based on a given query. Current techniques are unable to utilize collections of images, encountering an array of challenges such as variable or increased dimensionality resulting from concatenation, and potential loss of information, semantic meaning, and sensitivity to noise when summing or averaging embeddings.

### BRIEF DESCRIPTION OF THE DRAWINGS

Various examples will be described below with reference to the following figures.

FIG. 1 depicts an example system for entity retrieval based on image-group based signals, in accordance with some embodiments.

FIG. 2 depicts a system architecture for implementing the disclosed systems and methods, in accordance with some embodiments.

FIG. 3 depicts a reranking process for entity retrieval based on image-group based signals, in accordance with some embodiments.

FIG. 4 depicts an example method for entity retrieval based on image-group based signals, in accordance with some embodiments.

FIG. 5 depicts an example system for entity retrieval based on image-group based signals, in accordance with some embodiments.

FIG. 6 illustrates a block diagram of a computing device, in accordance with some embodiments.

### DETAILED DESCRIPTION

The disclosed systems and methods for entity retrieval based on image-group based signals provide a methodology to search image databases for entities represented by a collection of images by generating embeddings for the entities (e.g., via a trained machine learning model) and performing the search via the embedding space. Existing embedding-based search methods rely on pooling embeddings, which comes with challenges such as variable or increased dimensionality resulting from concatenation, and potential loss of information, semantic meaning, and sensitivity to noise when summing or averaging embeddings. Further details regarding the disclosed systems and methods for entity retrieval based on image-group based signals are provided below.

In some embodiments, a system including a processor and a non-transitory memory storing instructions is disclosed. The instructions, when executed, cause the processor to receive a plurality of catalog images each associated with at least one catalog item of a plurality of catalog items. For a respective catalog item of the plurality of catalog items, generate, based on a respective set of catalog images of the plurality of catalog images, respective catalog embeddings representing the respective set of catalog images, wherein the respective set of catalog images is associated with the respective catalog item. The instructions further cause the processor to receive a plurality of query images associated with a query item and based on the plurality of images, generate query embeddings representing the plurality of query images. For a respective query image of the plurality of query images associated with the query item, select, based on a comparison of the respective query image and the plurality of catalog images associated with the plurality of catalog items that meet a similarity criteria, a candidate set of the plurality of catalog items. Based on a comparison of the query embeddings representing the query item and respective catalog embeddings of the candidate set of the plurality of catalog items, generate respective similarity scores. Based on the respective similarity scores, determine that the query item is similar to a respective catalog item of the candidate set of the plurality of catalog items, and in response to the determination, identify the query item for review.

In some embodiments, a non-transitory computer readable-medium is disclosed. The non-transitory computer-readable medium includes instructions that, when executed, cause a processor to receive a plurality of catalog images each associated with at least one catalog item of a plurality of catalog items. For a respective catalog item of the plurality of catalog items, generate, based on a respective set of catalog images of the plurality of catalog images, respective catalog embeddings representing the respective set of catalog images, wherein the respective set of catalog images is associated with the respective catalog item. The instructions further cause the processor to receive a plurality of query images associated with a query item and based on the plurality of images, generate query embeddings representing the plurality of query images. For a respective query image of the plurality of query images associated with the query item, select, based on a comparison of the respective query image and the plurality of catalog images associated with the plurality of catalog items that meet a similarity criteria, a candidate set of the plurality of catalog items. Based on a comparison of the query embeddings representing the query item and respective catalog embeddings of the candidate set of the plurality of catalog items, generate respective similarity scores. Based on the respective similarity scores, determine that the query item is similar to a respective catalog item of the candidate set of the plurality of catalog items, and in response to the determination, identify the query item for review.

In some embodiments, a computer-implemented method is disclosed. The computer-implemented method includes receiving a plurality of catalog images each associated with at least one catalog item of a plurality of catalog items. For a respective catalog item of the plurality of catalog items, generating, based on a respective set of catalog images of the plurality of catalog images, respective catalog embeddings representing the respective set of catalog images, wherein the respective set of catalog images is associated with the respective catalog item. The method further includes receiving a plurality of query images associated with a query item and based on the plurality of images, generate query embeddings representing the plurality of query images. For a respective query image of the plurality of query images associated with the query item, selecting, based on a comparison of the respective query image and the plurality of catalog images associated with the plurality of catalog items that meet a similarity criteria, a candidate set of the plurality of catalog items. Based on a comparison of the query embeddings representing the query item and respective catalog embeddings of the candidate set of the plurality of catalog items, generating respective similarity scores. Based on the respective similarity scores, determining that the query item is similar to a respective catalog item of the candidate set of the plurality of catalog items, and in response to the determination, identifying the query item for review.

Furthermore, in the following, various embodiments are described with respect to methods and systems for entity retrieval utilizing image-group based signals. In various embodiments, an example system retrieves one or more entities utilizing one or more embeddings representative of a group of images, which provides improved accuracy of the relatedness between the query entity and associated query images and the retrieved entity and retrieved images as compared to systems utilizing a single image. Additionally, comparing groups of images reduces false positives that are overly reliant on a single similar image (e.g., an image that shows a color sample of the product).

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In some embodiments, systems, and methods for retrieving one or more entities utilizing signals generated for groups of images includes application of one or more trained machine learning models. The trained machine learning models may include one or more models, such as a Similar Entity Retrieval using Grouped Images (SERGI) model. In some embodiments, the SERGI model includes a Contrastive Language-Image Pre-training (CLIP) neural-network-based machine learning model.

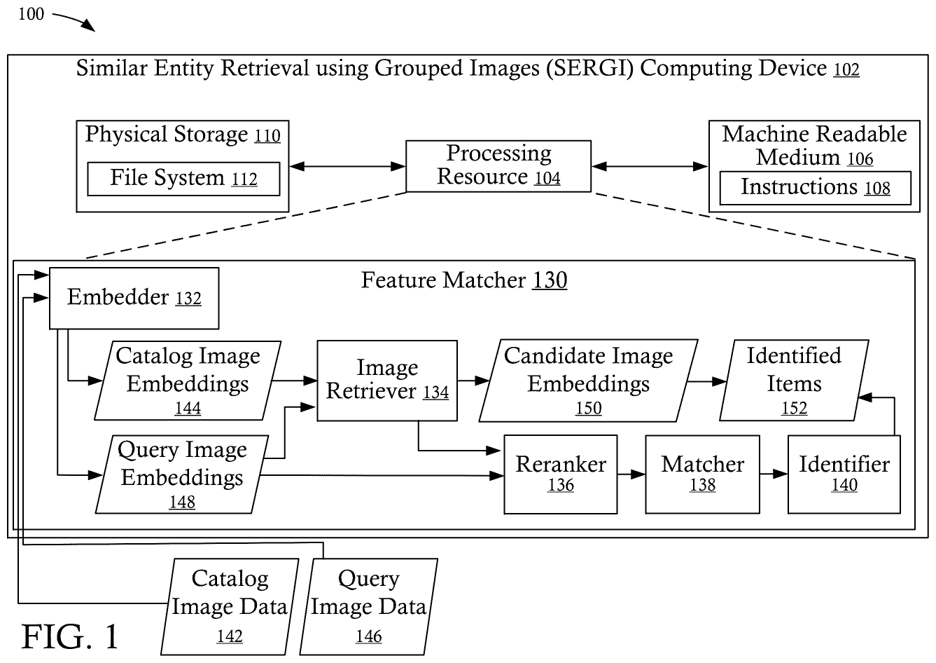

FIG. 1 depicts an example system 100 for entity retrieval utilizing image-group based signals, in accordance with some embodiments. The system 100 includes a SERGI computing device 102 that identifies one or more similar catalog items (e.g., one or more entities) for a query item based on one or more sets of catalog images respectively associated with the one or more catalog items. The SERGI computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The SERGI computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (e.g., programming or software code) stored on machine readable media 106 to perform functions of the SERGI computing device 102, such as receiving one or more sets of catalog images, receiving one or more sets of query images, generating one or more sets of catalog embeddings for the one or more sets of catalog images, generating one or more sets of query embeddings for the one or more sets of query images, comparing the one or more sets of catalog embeddings and the one or more sets of query embeddings, selecting a set of candidate catalog items based on the comparison of the catalog embeddings and the query embeddings, generating similarity scores based on comparing the catalog embeddings and the query embeddings, ranking the similarity of the candidate catalog items to the query item, and identifying the query item for review based on the similarity of at least one candidate catalog item and the query item meeting similarity criteria. The instructions 108 may include instructions for implementing one or more models. In some embodiments, and as will be described further herein below, the SERGI computing device 102 may execute one or more models, processes, or algorithms, such as a machine learning model, deep learning model, statistical model, large language model, etc., (e.g., as implemented as machine readable instructions) to generate embeddings for the query images, generate embeddings for the catalog images, compare the query images to the catalog images, compare the query embeddings to the catalog embeddings, etc.

The SERGI computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the simulation computing device 102. In some implementations, physical storage 110 may be accessed as a block storage device.

In some cases, the SERGI computing device 102 may also include a local file system 112 that may be implemented as a layer on top of the physical storage 110. For example, an operating system may be executing on the SERGI computing device 102 (by virtue of the processing resource 104 executing certain instructions 108 related to the operating system) and the operating system may provide a file system 112 to store data on the physical storage 110.

In various embodiments, the SERGI computing device 102 may be in communication with a web server, a cloud-based engine including one or more processing devices that may be provisioned for use, a database, a workstation, and/or any other suitable system or device. The SERGI computing device 102 may similarly be in communication, either directly or indirectly, with one or more user computing devices operatively coupled over a network. The other computing systems may be similar to the simulation computing device 102, and may each include at least a processing resource and a machine readable medium.

In some embodiments, the SERGI computing device 102 includes a feature matcher 130. The feature matcher 130 includes an embedder 132, an image retriever 134, a reranker 136, a matcher 138, and an identifier 140. The feature matcher 130 may implement a late-interaction architecture to compare sets of catalog images associated with catalog items to a set of query images from a query item. A late-interaction architecture improves query processing time by independently encoding sets of catalog images from catalog image data 142 as sets of catalog embeddings 144 and a set of query images from query image data 146 as a set of query embeddings 148. The late-interaction architecture further processes one or more interactions, such as similarity, between the independently encoded sets of catalog embeddings 144 and the set of query embeddings 148. In some embodiments, the late-interaction architecture allows for pre-computation of the catalog and query embeddings and allows for a more lightweight interaction step for the already encoded representations of the sets of catalog images and set of query images. Additional details regarding late-interaction architectures are provided below.

In some embodiments, the embedder 132 receives the catalog image data 142 and the query image data 146. The catalog image data 142 may include sets of catalog images associated with catalog items and the query image data 146 may include a set of query images associated with a query item. The catalog items may include one or more items (or entities) that are already included in an item catalog, such as items having known identifiers (e.g., items associated with known brands) and/or items that have been previously vetted and/or processed. The query item may include a new item that is intended to be added to the item catalog. For example, the query item may be a new item from a new seller that does not have any items listed in the item catalog. Additionally, each catalog item and/or query item may include a set of images that depict or include information about the respective item.

In some embodiments, the embedder 132 generates embeddings based on the received image data. For example, the embedder 132 may generate respective one or more catalog embeddings 144 based on respective sets of catalog images for a catalog item. Similarly, the embedder 132 may also generate one or more respective query embeddings 148 based on the set of query images. The embeddings may be generated by any suitable model or process, such as a deep-learning machine learning model.

In some embodiments, the embedder 132 implements an unsupervised model, such as a CLIP machine learning model. A CLIP machine learning model consists of a vision (e.g., image) transformer and a text transformer which are each trained to perform a contrastive prediction task. The vision transformer and the text transformer may also be trained to maximize a cosine similarity between an image and one or more other images in a shared set of images (e.g., images associated with a first item) while minimizing a cosine similarity between the image and one or more images in a different set of images (e.g., images associated with a second item).

In some embodiments, the embedder 132 receives one or more sets of catalog images from the catalog image data 142, with each set of catalog images being associated with a respective catalog item. Each catalog image may be embedded using a pretrained CLIP machine learning model via the embedder 132. The pretrained CLIP machine learning model may generate catalog embeddings 134 that maximize the similarity of catalog images in the same set (e.g., associated with the same catalog item), and minimize the cosine similarity of catalog images in other sets (e.g., associated with a different catalog item). In other words, the pretrained CLIP machine learning model may maximize the cosine similarity for catalog images of the same catalog product and minimize the cosine similarity for catalog images associated with different catalog products.

In some embodiments, the image retriever 134 receives the sets of catalog embeddings 144 and the set of query embeddings 148. For each query embedding of the set of query embeddings 148, the image retriever 134 identifies a catalog embedding that has a highest similarity criteria (e.g., the catalog embedding that is most similar to the query embedding). Next, based on information from a metadata database, the associated catalog item is identified and added to a set of candidate items to be compared with the query item.

In some embodiments, for each query embedding of the query embeddings, the image retriever 134 matches the respective query embedding with the most similar catalog image embedding of the catalog embeddings 134 via an approximate nearest neighbor search, and selects the catalog item associated with the most similar catalog image embedding as a candidate item. The identified candidate items may be returned as a set of candidate items.

In some embodiments, the reranker 136 receives the set of candidate items and the query embeddings 148. The reranker 136 retrieves sets of candidate image embeddings 150, which include embeddings selected from the sets of catalog image embeddings 144 that are associated with each respective candidate item of the set of candidate items as sets. The reranker 136 determines a maximum number of candidate image embeddings 150 associated with any one candidate item, and normalizes all the sets of candidate image embeddings 150 such that all the sets of candidate image embeddings 150 are uniform in this dimension. In some embodiments, the reranker 136 adds one or more default embeddings (e.g., a padding vector or padding embedding) to sets of candidate embeddings 150 that have fewer embeddings than the set of candidate image embeddings having the highest dimension in the sets of candidate image embeddings 150.

For example, the reranker 136 may receive two candidate items from the image retriever 134. The reranker 136 may query a first set of five candidate embeddings that is associated with a first candidate item and a second set of six candidate embeddings that is associated with a second candidate item. A padding vector may be added to the first set of five candidate embeddings such that the dimensions (e.g., number of embeddings) is the same between first set of candidate embeddings and the second set of candidate embeddings.

The reranker 136 may compare the set of query embeddings 136 with each set of candidate embeddings 150 associated with each candidate item. The re-ranker 136 may generate an output such as a similarity matrix for each comparison. In some embodiments, the comparison includes a Hadamard product of the query embeddings 136 with a respective one of the sets of candidate embeddings 150.

In some embodiments, the reranker 136 applies a MinAvg operator to each similarity matrix. The MinAvg operator may take a row-wise minimum and average the result for each similarity matrix to generate an entity-level scalar similarity score. The entity-level similarity score may represent an overall similarity of each of the query embeddings in the set of query embeddings 144 and each of a corresponding one of the candidate image embeddings 150 for each candidate item. The similarity scores may be directly used for reranking the candidate items and/or the similarity scores may be converted to a vector of Euclidean distances.

The reranker 136 outputs the reranked candidate items to the matcher 138, which selects a predetermined number of candidate items (e.g., top N candidate items where N is an integer greater than zero) that meet the similarity criteria. In some embodiments, the similarity criteria includes a minimum similarity score. For example, the matcher 144 may determine that none of the reranked candidate items meet the similarity criteria, and as such the matcher 138 may not select any of the reranked candidate items. As another example, the matcher 138 may determine that five of the reranked candidate items meet the similarity criteria and may select the top N reranked candidate items.

In some embodiments, the identifier 140 receives the selected reranked candidate items. In some embodiments, the identifier 140 marks the query item as an identified item 152. The identifier 140 may add the identified item 152 to the catalog and notify a user regarding the identified item 152. The identified item 152 and the selected reranked candidate items similar to the identified item 152 may be provided for review by a reviewer. In some embodiments, the reviewer may choose to allow the identified item 152 to be added to the catalog or the reviewer may choose to reject the identified item 152.

In some embodiments, training data is generated for one or more models (e.g., machine learning models, deep learning models, statistical models, algorithms, etc.) based on groups of images, etc. One or more models are trained based on corresponding training data. The trained models may be stored in a database, such as in a database (e.g., a cloud storage database).

The models, when executed by the SERGI computing device 102, allow the SERGI computing device 102 to identify a query item that is similar to one or more catalog items. For example, the SERGI computing device 102 may obtain one or more models from the database 122. The SERGI computing device 104 may then receive one or more query items with an associated set of images, and retrieve candidate items with associated sets of images. In response to receiving one or more candidate items that are similar to the query item, the SERGI computing device 102 may execute one or more models to determine that one or more candidate items are similar to the query item.

In some embodiments, the SERGI computing device 102 assigns the models (or parts thereof) for execution to one or more processing devices 120. For example, each model may be assigned to a virtual machine hosted by a processing device 122. The virtual machine may cause the models or parts thereof to execute on one or more processing units such as GPUs. In some embodiments, the virtual machines assign each model (or part thereof) among a plurality of processing units. Based on the output of the models, SERGI computing device 102 may generate a list of similar catalog items.

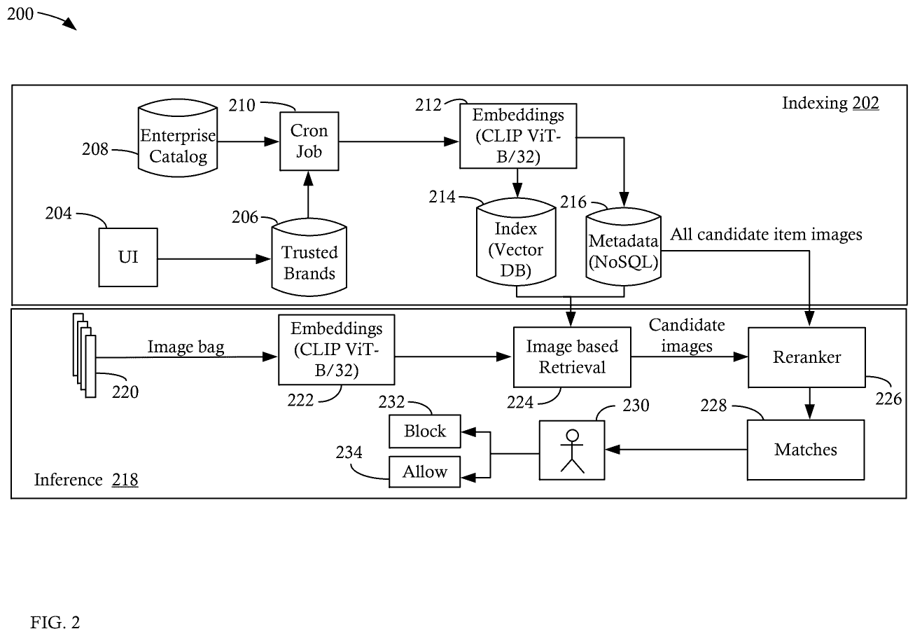

FIG. 2 depicts a system architecture 200 for implementing entity retrieval utilizing image-group based signals, in accordance with some embodiments. The system architecture 200 may include an indexing architecture 202 and an inference architecture 218. In some embodiments, the indexing architecture 202 converts images to vector representations and stores the vector representations to a low search-latency vector database.

The indexing architecture 202 may include a user interface (UI) 204 that receives information regarding one or more trusted items (e.g., sets of catalog images associated with one or more trusted items or item identifiers such as brand name). Trusted items may include items or identifiers that have already been validated (e.g., items that already have items in the catalog), and/or items or identifiers that have been manually approved. The information regarding the one or more trusted items are stored in a trusted entity database 206. In some embodiments, the indexing architecture 202 includes an enterprise catalog 208 that stores information regarding the one or more catalog items, including respective sets of catalog images associated with respective catalog items.

In some embodiments, information regarding the one or more trusted entity items from the trusted entities database 206 and information regarding the one or more catalog items from the enterprise catalog 208 are processed via a batch process 210 (e.g., a cron job). For example, a batch process 210 may execute daily and select new trusted entities that have been added via the UI 204 to the trusted entities database 206. Embeddings for the information regarding the one or more catalog items and the information regarding the one or more trusted entity items may be generated by a machine-learning-based embedder 212 (e.g., CLIP ViT-B/32). The embeddings (e.g., embeddings of the one or more sets of images associated with the one or more catalog items and/or the one or more trusted brand items) generated by the machine-learning-based embedder 212 may be indexed in a high-scale low-latency vector database 214 that may perform similarity matching using an approximate nearest neighbors search. Additional information associated with the embeddings may be stored in a low-latency database 216 (e.g., a NoSQL database).

In some embodiments, the inference architecture 218 receives one or more sets of query images 220 respectively associated with one or more query items (e.g., a new items that are not part of the catalog and are not from a trusted brand). The one or more sets of query images may be read in batches (e.g., via a cron job). Embeddings for each of the images in the one or more sets of query images may be generated by a machine-learning-based embedder 222. In some embodiments, the machine-learning-based embedder 222 is the same as the machine-learning-based embedder 212.

In some embodiments, the embeddings for each of the images in the one or more sets of query images are compared with the embeddings of the catalog images and/or the embeddings of the trusted entity images by an image-based retriever 224. In some embodiments, the image-based retriever 224 compares the embeddings based on the additional information stored in the metadata database 216.

In some embodiments, one or more candidate images are selected and sent to reranker 226. The one or more candidate images may be selected from one or more candidate items identified by matching each respective query embedding with a respective most-similar catalog image embedding. Additional details about selection of the one or more candidate images are provided in at least the description of FIG. 1.

In some embodiments, the reranker determines that one or more sets of the candidate images match the set of query images and sends the matches 228 to review process 230 for review. The review process 230 may block 232 the query image from being added to the enterprise catalog 208 or allow 234 the query item to be added to the enterprise catalog 208. The review process 230 may be an automated review process or a manual review process by a user.

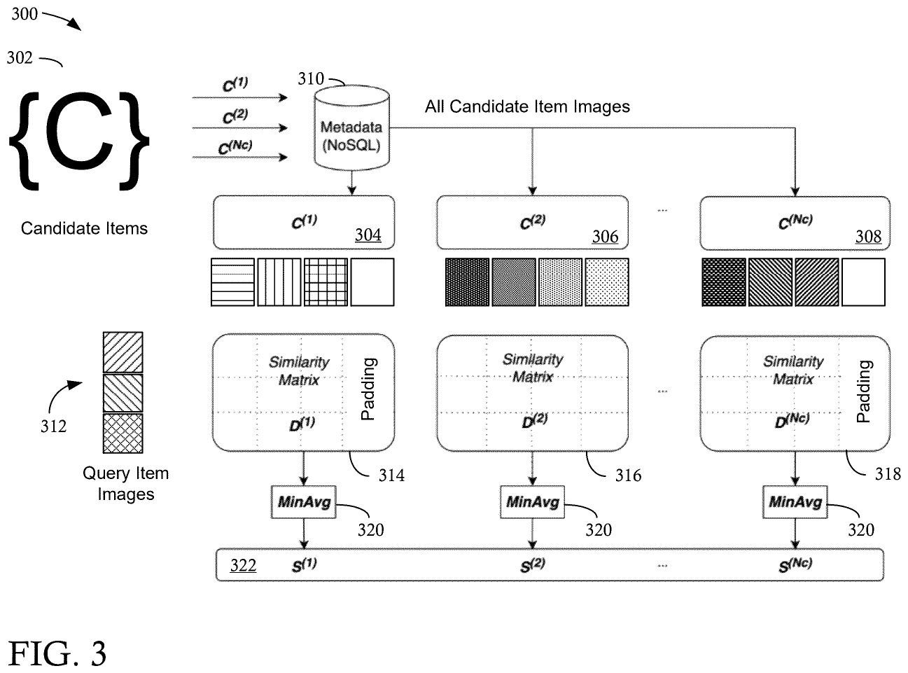

FIG. 3 depicts a reranking process 300, in accordance with some embodiments. In some embodiments, the reranking process begins with a set of candidate products 302. Sets of candidate product images and/or sets of catalog image embeddings associated with candidate product images 304, 306, and 308 are retrieved from the metadata database 310 (e.g., similar to the metadata base 216 as described with reference to FIG. 2) based on the set of candidate products 302.

In some embodiments, the set of candidate items 302 includes a unique identifier of each candidate item, and a respective set candidate item images and/or set of catalog image embeddings associated with the candidate item images are retrieved from the metadata database 216 based on matching the unique identifier of each candidate item to a corresponding identifier associated with the candidate item images. For example, a first set of catalog image embeddings 304 associated with a first candidate item, a second set of catalog image embeddings 306 associated with a second candidate item, and a third set of catalog image embeddings 308 associated with a third candidate item may be retrieved from the metadata database 216.

The sets of catalog image embeddings may be compared with a set of query image embeddings 312 associated with a set of query product images. Each comparison generates a similarity matrix (e.g., similarity matrices 314, 316, and 318). For example, a comparison of the first set of catalog image embeddings 304 with the set of query image embeddings 312 may return similarity matrix 314, a comparison of the second set of catalog image embeddings 306 with the set of query image embeddings 312 may return similarity matrix 316, and a comparison of the third set of catalog image embeddings 308 with the set of query image embeddings 312 may return similarity matrix 318.

In some embodiments, each similarity matrix is reduced to a scalar value by a MinAvg operator 320. For each similarity matrix, the MinAvg operator 320 may take an average of the row-wise minimums. Each scalar representation of the similarity matrix may be added to a similarity array 322. In some embodiments, the similarity array is reranked from most similar to least similar (e.g., largest similarity value to the smallest similarity value).

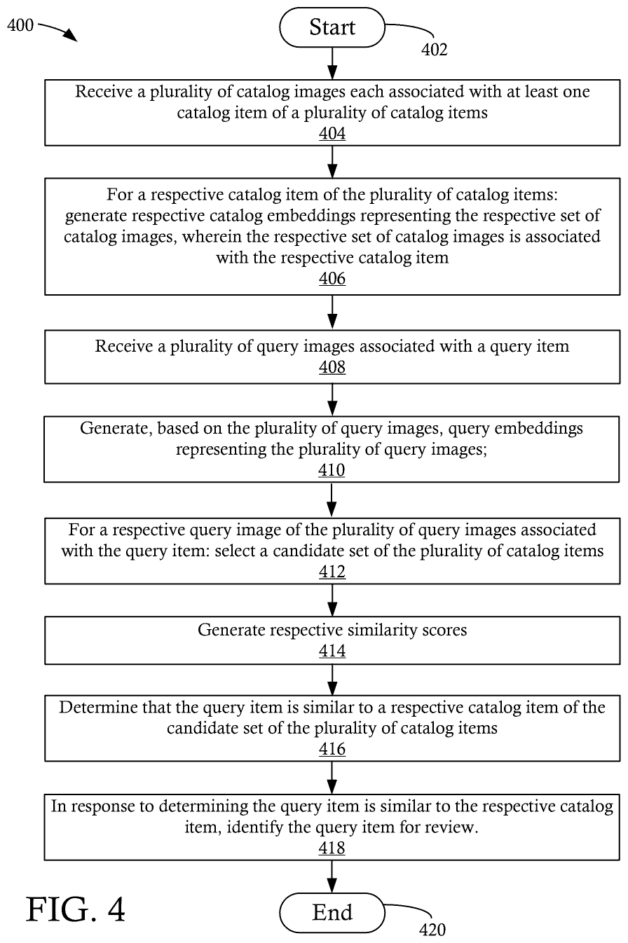

FIG. 4 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 4 may be implemented in the form of executable instructions stored on machine-readable media and executed by a processing resource and/or in the form of electronic circuitry. For example, aspects of the methods may be described below as being performed by a similarity system, an example of which may be the feature matcher 130 running on a hardware processing resource 104 of the SERGI computing device 102 described above. Additionally, other aspects of the methods described below may be described with reference to other elements shown in FIG. 1 for non-limiting illustration purposes.

FIG. 4 depicts an example method 400 for entity retrieval based on image-group based signals, in accordance with some embodiments. The method 400 starts at block 402 and continues to block 404, where a plurality of catalog images are received. The plurality of catalog images are each associated with at least one catalog item of a plurality of catalog items. The method 400 continues to block 406, where respective catalog embeddings representing the respective set of catalog images are generated for a respective catalog item of the plurality of catalog items. The respective catalog embeddings may be generated by a CLIP machine learning model that maximize the similarity of catalog images in the same set (e.g., associated with the same catalog item), and minimize the cosine similarity of catalog images in other sets (e.g., associated with a different catalog item). In other words, the pretrained CLIP machine learning model may maximize the cosine similarity for catalog images of the same catalog product and minimize the cosine similarity for catalog images associated with different catalog products.

The method 400 continues to block 408, where a plurality of query images associated with a query item is received. The method 400 continues to block 410, where query embeddings representing the plurality of query images is generated based on the plurality of query images. In some embodiments, the method may include generating the query embeddings by the same pretrained CLIP machine learning model that was used to generate the catalog embeddings.

The method 400 continues to block 412, where a candidate set of the plurality of catalog items is selected for a respective query image of the plurality of query images associated with the query item. The method may include matching the respective query embedding with the most similar catalog image embedding of the catalog embeddings via an approximate nearest neighbor search, and selecting the catalog item associated with the most similar catalog image embedding as a candidate item. The identified candidate items may be returned as a set of candidate items.

The method 400 continues to block 414, where respective similarity scores are generated. In some embodiments, the method includes generating similarity matrices by comparing the sets of catalog image embeddings with a set of query image embeddings. A similarity matrices may be reduced to a scalar value (e.g., the similarity score) by an operator, such as a MinAvg operator that takes an average of the row-wise minimums of the respective similarity matrix.

The method 400 continues to block 416, where the query item is determined to be similar to a respective catalog item of the candidate set of the plurality of catalog items. The method may determine that the query item is similar to a respective catalog item based on at least one similarity score meeting similarity criteria (e.g., at least one similarity score is higher than a similarity threshold).

The method continues to block 418, where in response to determining the query item is similar to the respective catalog item, the query item is identified for review. In some embodiments, the query item is provided to a reviewer or review process. The reviewer may choose to allow the identified query item to be added to the catalog, or the reviewer may choose to reject the identified query item. The method ends at block 420.

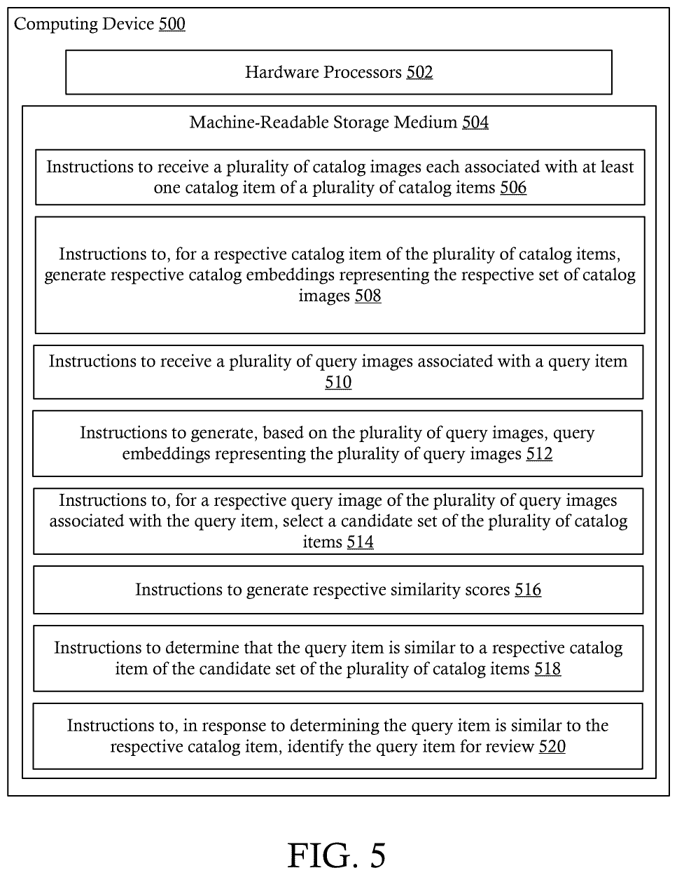

FIG. 5 depicts an example system 500 that includes non-transitory, machine-readable media 504 encoded with example instructions executable by processing resource 502. In some implementations, the system 500 may be useful for implementing aspects of the feature matcher 130 of FIG. 1. For example, the instructions encoded on machine-readable media 504 may be included in instructions 108 of FIG. 1. In some implementations, functionality described with respect to FIG. 1 may be included in the instructions encoded on machine-readable media 504.

The processing resource 502 may include a microcontroller, a microprocessor, central processing unit core(s), an ASIC, an FPGA, and/or other hardware device suitable for retrieval and/or execution of instructions from the machine-readable media 504 to perform functions related to various examples. Additionally or alternatively, the processing resource 502 may include or be coupled to electronic circuitry or dedicated logic for performing some or all of the functionality of the instructions described herein.

The machine-readable media 504 may be any medium suitable for storing executable instructions, such as RAM, ROM, EEPROM, flash memory, a hard disk drive, an optical disc, or the like. In some example implementations, the machine-readable media 504 may be a tangible, non-transitory medium. The machine-readable media 504 may be disposed within the system 500 respectively, in which case the executable instructions may be deemed installed or embedded on the system. Alternatively, the machine-readable media 504 may be a portable (e.g., external) storage medium, and may be part of an installation package.

As described further herein below, the machine-readable media 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 5.

With reference to FIG. 5, the machine-readable media 504 includes instructions 506-520. Instructions 506, when executed, cause the processing resource 502 to receive a plurality of catalog images each associated with at least one catalog item of a plurality of catalog items. Instructions 508, when executed, cause the processing resource 502 to generate respective catalog embeddings representing the respective set of catalog images for a respective catalog item of the plurality of catalog items. Instructions 510, when executed, cause the processing resource 502 to receive a plurality of query images associated with a query item 510. Instructions 512, when executed, cause the processing resource 502 to generate query embeddings representing the plurality of query images based on the plurality of query images. Instructions 514, when executed, cause the processing resource 502 to select a candidate set of the plurality of catalog items for a respective query image of the plurality of query images associated with the query item. Instructions 516, when executed, cause the processing resource 502 to generate respective similarity scores. Instructions 518, when executed, cause the processing resource 518 to determine that the query item is similar to a respective catalog item of the candidate set of the plurality of catalog items. Instructions 520, when executed, cause the processing resource 502 to identify the query item for review in response to determining the query item is similar to the respective catalog item.

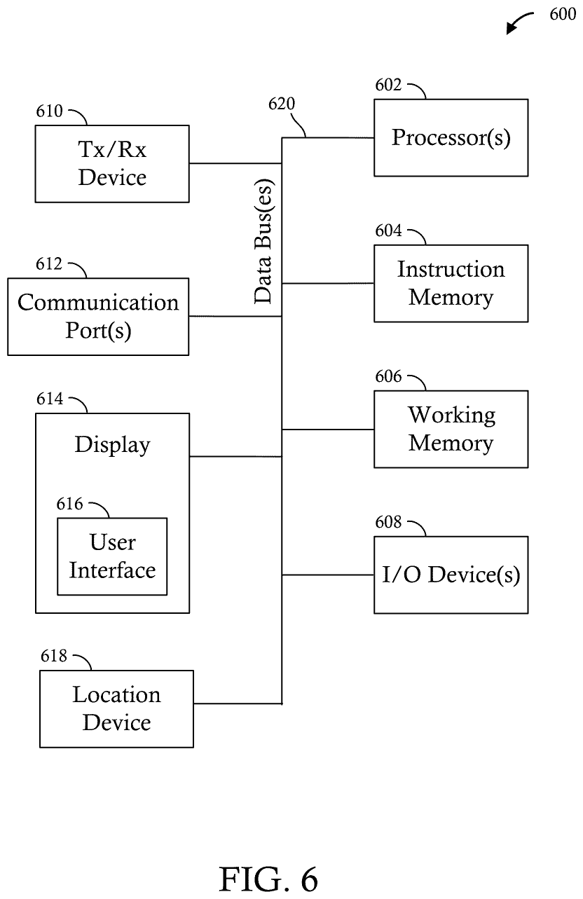

FIG. 6 illustrates a block diagram of a computing device 600, in accordance with some embodiments. Although FIG. 6 is described with respect to certain components shown therein, it will be appreciated that the elements of the computing device 600 may be combined, omitted, and/or replicated. In addition, it will be appreciated that additional elements other than those illustrated in FIG. 6 may be added to the computing device.

As shown in FIG. 6, the computing device 600 may include one or more processing resources 602, instruction memory 604, working memory 606, input/output devices 608, transceiver 610, communication ports 612, display 614, optional location device 618, and/or any other suitable elements each operatively coupled to one or more data buses 620. The data buses 620 allow for communication among the various components. The data buses 620 may include wired, or wireless, communication channels.

The one or more processing resources 602 may include any processing circuitry operable to control operations of the computing device 600. In some embodiments, the one or more processing resources 602 include one or more distinct processors, each having one or more cores (e.g., processing circuits). Each of the distinct processors may have the same or different structure. The one or more processing resources 602 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 602 may also be implemented by a controller, a microcontroller, an application specific integrated circuit (ASIC), a field programmable gate array (FPGA), a programmable logic device (PLD), etc.

In some embodiments, the one or more processing resources 602 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 604 may store instructions that are accessed (e.g., read) and executed by at least one of the one or more processing resources 602. For example, the instruction memory 604 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 602 may perform a certain function or operation by executing code, stored on the instruction memory 604, embodying the function or operation. For example, the one or more processing resources 602 may execute code stored in the instruction memory 604 to perform one or more of any function, method, or operation disclosed herein.

Additionally, the one or more processing resources 602 may store data to, and read data from, the working memory 606. For example, the one or more processing resources 602 may store a working set of instructions to the working memory 606, such as instructions loaded from the instruction memory 604. The one or more processing resources 602 may also use the working memory 606 to store dynamic data created during one or more operations. The working memory 606 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 604 and working memory 606, it will be appreciated that the computing device 600 may include a single memory unit that operates as both instruction memory and working memory. Further, although embodiments are discussed herein including non-volatile memory, it will be appreciated that computing device 600 may include volatile memory components in addition to at least one non-volatile memory component.

In some embodiments, the instruction memory 604 and/or the working memory 606 includes an instruction set, in the form of a file for executing various methods, such as methods for entity retrieval based on image-group based signals, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 602.

The input/output devices 608 may include any suitable device that allows for data input or output. For example, the input/output devices 608 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 610 and/or the communication port(s) 612 allow for communication with a network. For example, if a communication network is a cellular network, the transceiver 610 allows communications with the cellular network. In some embodiments, the transceiver 610 is selected based on the type of the communication network the computing device 600 will be operating in. The one or more processing resources 602 are operable to receive data from, or send data to, a network, via the transceiver 610.

The communication port(s) 612 may include any suitable hardware, software, and/or combination of hardware and software that is capable of coupling the computing device 600 to one or more networks and/or additional devices. The communication port(s) 612 may be arranged to operate with any suitable technique for controlling information signals using a desired set of communications protocols, services, or operating procedures. The communication port(s) 612 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 612 allows for the programming of executable instructions in the instruction memory 604. In some embodiments, the communication port(s) 612 allow for the transfer (e.g., uploading or downloading) of data, such as machine learning model training data.

In some embodiments, the communication port(s) 612 couples the computing device 600 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 610 and/or the communication port(s) 612 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 614 may be any suitable display, and may display the user interface 614. The user interfaces 616 may enable user interaction with the image-based search system. For example, the user interface 616 may be a user interface for an application of a network environment operator that allows a user to view and interact with the operator's website. In some embodiments, a user may interact with the user interface 616 by engaging the input/output devices 58. In some embodiments, the display 614 may be a touchscreen, where the user interface 66 is displayed on the touchscreen.

The display 614 may include a screen such as, for example, a Liquid Crystal Display (LCD) screen, a light-emitting diode (LED) screen, an organic LED (OLED) screen, a movable display, a projection, etc. In some embodiments, the display 614 may include a coder/decoder, also known as Codecs, to convert digital media data into analog signals. For example, the visual peripheral output device may include video Codecs, audio Codecs, or any other suitable type of Codec.

The optional location device 618 may be communicatively coupled to a location network and operable to receive position data from the location network. For example, in some embodiments, the location device 618 includes a GPS device that receives position data identifying a latitude and longitude from one or more satellites of a GPS constellation. As another example, in some embodiments, the location device 618 is a cellular device that receives location data from one or more localized cellular towers. Based on the position data, the computing device 600 may determine a local geographical area (e.g., town, city, state, etc.) of its position.

In some embodiments, the computing device 600 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 600 may be a computer, a workstation, a laptop, a server such as a cloud-based server, or any other suitable device. In some embodiments, the computing device 600 is a server that includes one or more processing units, such as one or more graphical processing units (GPUs), one or more central processing units (CPUs), and/or one or more processing cores. The computing device 600 may, in some embodiments, execute one or more virtual machines. In some embodiments, processing resources (e.g., capabilities) of the computing device 600 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that determining similar items based on groups of images as disclosed herein, particularly on large datasets intended to be used with the disclosed embodiments, is only possible with the aid of computer-assisted machine-learning algorithms and techniques, such as a late-interaction architecture machine learning model and/or a CLIP model. In some embodiments, machine learning processes including a late-interaction architecture machine learning model and/or a CLIP model are used to perform operations that cannot practically be performed by a human, either mentally or with assistance, such as a late-interaction architecture machine learning model and/or a CLIP model. It will be appreciated that a variety of machine learning techniques can be used alone or in combination to generate a late-interaction architecture machine learning model and/or a CLIP model.

In some embodiments, a new item with an associated set of images is received. The set of images associated with the new item may be embedded by a CLIP machine learning model. The embeddings of the set of images associated with the new item may be compared to embeddings of the sets of images associated with trusted items (e.g., items that have already been validated, are already in the catalog, and/or items that have been manually approved), which may be embedded by the same CLIP machine learning model. The comparison may return similarity scores that represent similarity between the new item and the trusted items. In accordance with a determination that the similarity score meets similarity criteria, the new item is sent to a review process. The review process may block the new item from being added to the catalog or allow the new item to be added to the enterprise catalog.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a plurality of catalog images each associated with at least one catalog item of a plurality of catalog items;
for a respective catalog item of the plurality of catalog items:
generate, based on a respective set of catalog images of the plurality of catalog images, respective catalog embeddings representing the respective set of catalog images, wherein the respective set of catalog images is associated with the respective catalog item;
receive a plurality of query images associated with a query item;
generate, based on the plurality of query images, query embeddings representing the plurality of query images;
for a respective query image of the plurality of query images associated with the query item:
select, based on a comparison of the respective query image and the plurality of catalog images associated with the plurality of catalog items that meet a similarity criteria, a candidate set of the plurality of catalog items;
generate, based on a comparison of the query embeddings representing the query item and the respective catalog embeddings of the candidate set of the plurality of catalog items, respective similarity scores;
determine, based on the respective similarity scores, that the query item is similar to a respective catalog item of the candidate set of the plurality of catalog items; and
in response to determining the query item is similar to the respective catalog item, identify the query item for review.

2. The system of claim 1, wherein the respective catalog embeddings maximize a cosine similarity between the respective set of catalog images, and the respective catalog embeddings minimize the cosine similarity of the respective set of catalog images and another respective set of catalog images associated with another catalog item of the plurality of catalog items.

3. The system of claim 1, wherein generating the respective similarity scores includes generating a similarity matrix based on a Hadamard product between the query embeddings and each respective catalog embedding of the respective catalog embeddings of the candidate set of the plurality of catalog items.

4. The system of claim 3, wherein generating a respective similarity score is based on averaging row-wise minimums for each row of the similarity matrix to reduce each similarity matrix to a single scalar value.

5. The system of claim 3, further comprising instructions that when executed cause the processor to:
normalize, based on a default vector, the respective catalog embeddings representing the respective plurality of catalog images associated with the respective catalog item and the query embeddings representing the plurality of query images associated with the query item, wherein the respective catalog embeddings representing the respective plurality of catalog images and the query embeddings representing the plurality of query images are uniform in dimensions after normalization; and
wherein the default vector is distinct from the respective catalog embeddings representing the respective plurality of catalog images and the query embeddings representing the plurality of query images.

6. The system of claim 1, wherein the respective catalog embeddings representing the respective plurality of catalog images associated with the respective catalog item and the query embeddings representing the plurality of query images associated with the query item are generated via an unsupervised machine learning model.

7. The system of claim 1, wherein identifying the query item for review includes notifying a user that the query item is similar to one or more catalog items of the plurality of catalog items.

8. The system of claim 1, wherein identifying the query item for review includes preventing the query item from being added to the plurality of catalog items.

9. A computer-implemented method, comprising:
receiving a plurality of catalog images each associated with at least one catalog item of a plurality of catalog items;
for a respective catalog item of the plurality of catalog items:
generating, based on a respective set of catalog images of the plurality of catalog images, respective catalog embeddings representing the respective set of catalog images, wherein the respective set of catalog images is associated with the respective catalog item;
receiving a plurality of query images associated with a query item;
generating, based on the plurality of query images, query embeddings representing the plurality of query images;
for a respective query image of the plurality of query images associated with the query item:
selecting, based on a comparison of the respective query image with the plurality of catalog images associated and the plurality of catalog items meeting a similarity criteria, a candidate set of the plurality of catalog items;
generating, based on a comparison of the query embeddings representing the query item and the respective catalog embeddings of the candidate set of the plurality of catalog items, respective similarity scores;
determining, based on the respective similarity scores, that the query item is similar to a respective catalog item of the candidate set of the plurality of catalog items; and
in response to determining the query item is similar to the respective catalog item, identifying the query item for review.

10. The computer-implemented method of claim 9, wherein the respective catalog embeddings maximize a cosine similarity between the respective set of catalog images, and the respective catalog embeddings minimize the cosine similarity of the respective set of catalog images and another respective set of catalog images associated with another catalog item of the plurality of catalog items.

11. The computer-implemented method of claim 9, wherein generating the respective similarity scores includes generating a similarity matrix based on a Hadamard product between the query embeddings and each respective catalog embedding of the respective catalog embeddings of the candidate set of the plurality of catalog items.

12. The computer-implemented method of claim 11, wherein generating a respective similarity score is based on averaging row-wise minimums for each row of the similarity matrix to reduce each similarity matrix to a single scalar value.

13. The computer-implemented method of claim 11, further comprising:
normalizing, based on a default vector, the respective catalog embeddings representing the respective plurality of catalog images associated with the respective catalog item and the query embeddings representing the plurality of query images associated with the query item, wherein the respective catalog embeddings representing the respective plurality of catalog images and the query embeddings representing the plurality of query images are uniform in dimensions after normalization; and
wherein the default vector is distinct from the respective catalog embeddings representing the respective plurality of catalog images and the query embeddings representing the plurality of query images.

14. The computer-implemented method of claim 9, wherein the respective catalog embeddings representing the respective plurality of catalog images associated with the respective catalog item and the query embeddings representing the plurality of query images associated with the query item are generated via an unsupervised machine learning model.

15. The computer-implemented method of claim 9, wherein identifying the query item for review includes notifying a user that the query item is similar to one or more catalog items of the plurality of catalog items.

16. The computer-implemented method of claim 9, wherein identifying the query item for review includes preventing the query item from being added to the plurality of catalog items.

17. A non-transitory computer readable medium comprising instructions that when executed cause a processor to:
receive a plurality of catalog images each associated with at least one catalog item of a plurality of catalog items;
for a respective catalog item of the plurality of catalog items:
generate, based on a respective set of catalog images of the plurality of catalog images, respective catalog embeddings representing the respective set of catalog images, wherein the respective set of catalog images is associated with the respective catalog item;
receive a plurality of query images associated with a query item;
generate, based on the plurality of query images, query embeddings representing the plurality of query images;
for a respective query image of the plurality of query images associated with the query item:
select, based on a comparison of the respective query image and the plurality of catalog images associated with the plurality of catalog items meeting a similarity criteria, a candidate set of the plurality of catalog items;
generate, based on a comparison of the query embeddings representing the query item and the respective catalog embeddings of the candidate set of the plurality of catalog items, respective similarity scores;
determine, based on the respective similarity scores, that the query item is similar to a respective catalog item of the candidate set of the plurality of catalog items; and
in response to determining the query item is similar to the respective catalog item, identifying the query item for review.

18. The non-transitory computer readable medium of claim 17, wherein the respective catalog embeddings maximize a cosine similarity between the respective set of catalog images, and the respective catalog embeddings minimize the cosine similarity of the respective set of catalog images and another respective set of catalog images associated with another catalog item of the plurality of catalog items.

19. The non-transitory computer readable medium of claim 17, wherein generating the respective similarity scores includes generating a similarity matrix based on a Hadamard product between the query embeddings and each respective catalog embedding of the respective catalog embeddings of the candidate set of the plurality of catalog items.

20. The non-transitory computer readable medium of claim 19, wherein generating a respective similarity score is based on averaging row-wise minimums for each row of the similarity matrix to reduce each similarity matrix to a single scalar value.
